(19) United States
(12) Patent Application Publication
(10) Pub. No.: US 2025/0139547 A1
(43) Pub. Date: May 1, 2025

(54) PREDICTIVE ESTIMATION OF AN AMOUNT OF COATING FOR A SURFACE COATING APPLICATION

(71) Applicant: SWIMC LLC, Cleveland, OH (US)

(72) Inventors: Angela SIMONE, Avon, OH (US); Thomas J. STAUNTON, Euclid, OH (US)

(21) Appl. No.: 18/689,494

(22) PCT Filed: Sep. 27, 2022
(86) PCT No.: PCT/US2022/044860

§ 371 Date: Mar. 6, 2024

Related U.S. Application Data
(60) Provisional application No. 63/250,570, filed on Sep. 30, 2021.

(51) Int. Cl. G06Q 10/0631; G06Q 10/20; G06Q 30/0283

(52) U.S. Cl. CPC G06Q 10/06315; G06Q 10/20; G06Q 30/0283

(57) ABSTRACT

One or more techniques and/or systems are disclosed for providing for improved coating usage estimation, wherein a plurality of inputs associated with a surface coating application are received. The plurality of inputs include one or more of a target coating surface area, a method of application of the coating, a surface substrate type, and a coating type. Application properties for the surface coating application are determined based on the received plurality of inputs. An amount of coating sufficient to complete the surface coating application is estimated based on the determined application properties. The estimated amount of coating corresponding to a total amount of coating to be prepared for the surface coating application is output.

### BACKGROUND

Different coating materials, such as paint, are available for different types of applications. In painting applications, for example, specialty paints include a base paint mixed with colorants to a desired final color for a specific project or job. As such, the final paint color is specific to the project or job, with any paint not used being wasted. Because an individual (e.g., a paint mixer) uses an estimated size of the paint job and the individual's experience (e.g., to determine if extra paint should be mixed to allow for the color to be blended or if the paint is limited to, for example, a repair area) to estimate the amount of paint needed for the paint job, wasted paint is not uncommon.

In order to reduce waste and cost, a conservative estimate as to the amount of paint needed for the paint job is often used. As a result, not enough paint may be mixed and the painter has to return to the paint store to obtain more paint, resulting in wasted time and increased cost. In some instances, in order to avoid multiple trips to the paint store, a less conservative estimate to the amount of paint is made, but this can result in wasted paint (e.g., when there is extra paint at the end of the paint job) and the associated cost.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein can be utilized for coating usage prediction or estimation. For example, systems and methods of predicting an amount of coating needed for a surface coating application, described herein, can utilize a combination of coating variables to more accurately estimate an amount of coating material needed for the surface coating application.

In one implementation for providing for improved coating usage estimation, a plurality of inputs associated with a surface coating application are received. The plurality of inputs include one or more of a target coating surface area, a method of application of the coating, a surface substrate type, and a coating type. Application properties for the surface coating application are determined based on the received plurality of inputs. An amount of coating sufficient to complete the surface coating application is estimated based on the determined application properties. The estimated amount of coating corresponding to a total amount of coating to be prepared for the surface coating application is output.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a block diagram illustrating one implementation of a coating usage predictor.

FIG. 2 is a block diagram illustrating one implementation of a coating usage prediction system.

FIG. 3 illustrates an example implementation of a method for performing coating usage prediction operations.

FIG. 4 is a block diagram of an example computing environment suitable for implementing various examples of well-being monitoring.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The methods and systems disclosed herein, for example, may be suitable for use in mixing coating (e.g., paints, stains, varnishes, chemicals, etc.) for different coating applications. For example, automated predictive estimation of an amount of coating for a project or job, such as a surface coating application, utilizes a plurality of input variables to generate a more accurate prediction of the amount of coating that is to be used, as well as the specific mixing properties of that coating. It should be appreciated that the herein described examples can be used in different settings or environments for different types of coating applications and with different coating materials. The examples given herein are merely for illustration.

In some implementations, a coating usage estimator is configured to determine an amount of coating needed for the surface coating application (e.g., a paint project or job). In one example of a painting application, the amount of primer, basecoat, and clearcoat for new application or for a repair application is estimated based on the plurality of input variables. In some examples, the coating usage estimator is used in a painting application in combination with one or more paint mixer prediction systems that estimate the amount of different colorants to add to a base paint in order to achieve a desired application color. For example, a user (e.g., customer) facing improvement to a color retrieval system is provided that can result in the user's coating process being faster, reducing coating waste and/or reducing the need to mix additional coating to complete the application. That is, more accurate coating amount predictions can be made compared to conventional approaches. In this manner, when a processor is programmed to perform the operations described herein, the processor is used in an unconventional way that allows for more efficient and accurate coating usage prediction, which results in an improved user (e.g., customer) experience. Further, inputs retrieved from real-world situations or applications are converted into real-world usable results, for example, where the coatings application data is transformed into an actual amount of coating for the target application, and where the coating has the desired color.

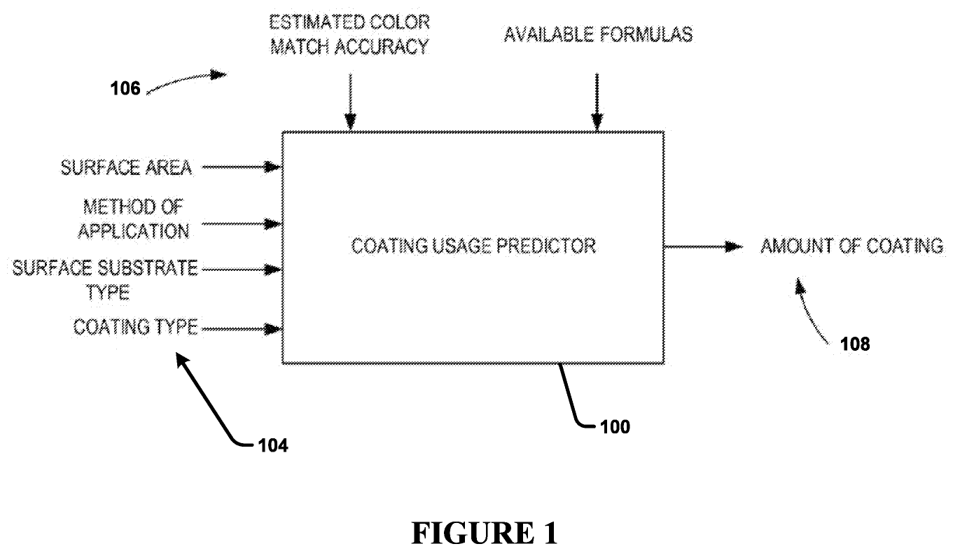

As an example, a coating usage predictor 100 is illustrated in FIG. 1. The coating usage predictor 100 is configured to receive one or more inputs, such as coating variables 104 (e.g., also referred to as coating variables), which can be any variables that affect the surface coating application. In the illustrated example, the coating variables 104 include surface area, method of application, surface substrate type, and coating type. However, it should be appreciated that the illustrated coating variables 104 are merely for example, and other variables can be used by the coating usage predictor 100.

With respect to the illustrated coating variables 104, following are one or more factors or characteristics for each:
1. Surface area—the calculated or estimated area of the target coating area corresponding to the surface coating application. In some examples, the target coating surface area includes a target area to be coated (e.g., to be sprayed or otherwise applied), and, ins some applications, a repair area. That is, the target coating surface area can include the surface upon which coating is to be applied, which can also include therein an area targeted for repair, in some examples. As such, the surface area can include an overall area and one or more sub-areas in some examples.
2. Method of application—the instrument, tool, or applicator to be used, and the method used to apply the coating. For example, a type of sprayer to be used (e.g., airless, air-powered), a type of roller or brush to be used (e.g., or similar applicator), etc. In some examples, the application type also includes other factor for the application, such as the target application thickness, application rate, number of coatings used, etc.
3. Surface substrate type—the material or composition of the surface on which the coating is to be applied. For example, the surface can be defined by the material makeup thereof that includes already coated areas, if any. Some examples includes a metal substrate, interior or exterior drywall, masonry, wood, plastic, etc. Often, for example, the type of substrate, type of existing coating, porosity of the substrate, and other factors can help determine an application rate for the substrate.
4. Coating type—the properties of the coating to be applied. For example, the coating type can include the color, the composition of the coating (e.g., paint type), etc.

In some examples, the coating usage predictor 100 receives additional inputs 106 that are utilized to estimate or predict the coating usage, such as target application environmental conditions (e.g., temperature, humidity, etc. at time of application). As another example, as illustrated in FIG. 1, the additional inputs 106 can include an estimated color match accuracy and one or more available coating formulas (e.g., paint formulas). As described in more detail herein, the additional inputs 106 can be used to increase or decrease the predicted coating usage.

In operation, the coating usage predictor 100 receives the coating variables 104 and the additional inputs 106, processes the coating variables 104 and the additional inputs 106, and generates as an output, an estimated amount of coating 108 for the surface coating application. For example, in some painting applications, a predicted or estimated mix amount can include an estimated amount of primer, an estimated amount of basecoat, and an estimated amount of clearcoat for the application. In some examples, other amounts of material or components/constituents for the coating can be estimated, such as an estimated amount of one or more colorants.

In some examples, one or more algorithms are used by the coating usage predictor 100 to predict or estimate the amount of coating for the surface coating application. For example, the coating usage predictor 100 is configured to use combinational or computational algorithmic logic to process the coating variables 104 and optionally the additional inputs 106 to predict or estimate the amount of coating for the surface coating application. In one example, empirical, experimental or simulation data is used to train or configure the coating usage predictor 100, and then the coating variables 104 and optionally the additional inputs 106 are processed to predict or estimate the amount of coating for the surface coating application. In some examples, machine learning is used to train or configure the coating usage predictor 100 based on a training data from simulations or feedback received from previously predicted amounts to converge to a more accurate result. In some examples, artificial intelligence (AI) is used as part of the training and/or processing of the coating usage predictor 100 to converge to a more accurate result. Further, ongoing training can be used to periodically update the prediction results of the combinational or computational algorithmic logic.

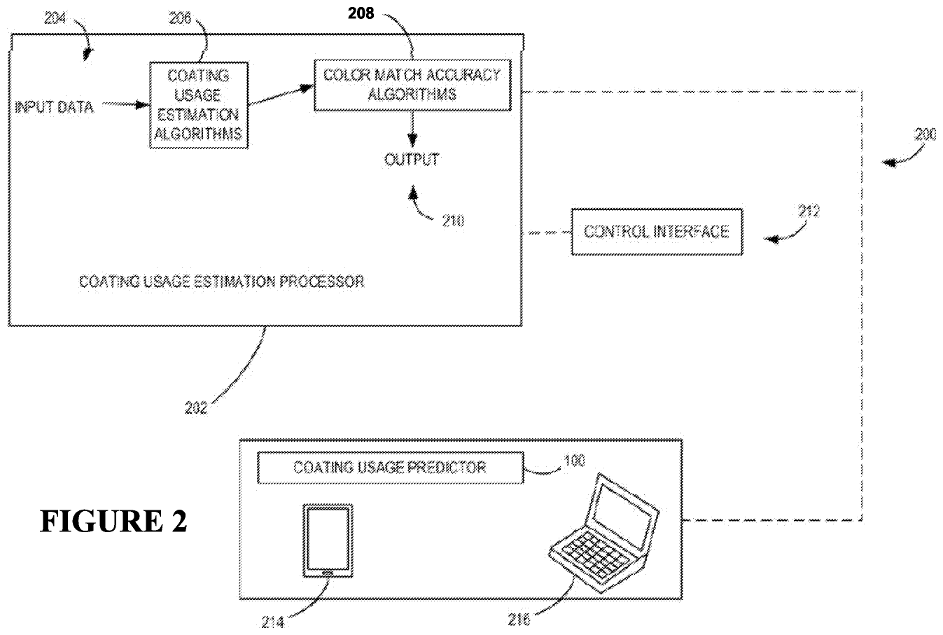

One particular implementation includes a coating usage prediction system 200 as illustrated in FIG. 2. In some examples, the coating usage prediction system 200 is implemented as part of, or includes, the coating usage predictor 100. The coating usage prediction system 200, in one example, is a processing machine that can be used in combination with one or more other coating mixing systems to produce a desired or suggested amount of mixed coating. More particularly, the coating usage prediction system 200 includes a coating usage estimation processor 202 that is configured as a processing engine that performs coating amount estimation or prediction for a surface coating application using input data 204, which can include the coating variables 104 and optionally the additional inputs 106. It should be noted that the input data 204 can include different types of data configured in different ways corresponding to different types of coatings, different applications to be performed, etc. It should also be noted that the examples described in the present disclosure can be applied to different types of data, including non-coating data.

The coating usage estimation processor 202 has access to the input data 204, such as the different types of coating variables or properties. For example, the coating usage estimation processor 202 accesses coating variables received as inputs for a surface coating application to be performed (e.g., as part of a repair job) for use in performing coating amount estimation or prediction. In some implementations, the input data 204 can be stored (e.g., at least temporarily) in local or remote memory for use by the estimation processor 202. It should be appreciated that the coating usage estimation processor 202 is configured to perform coating amount estimation or prediction in a wide variety of application domains. For example, the implementations of the present disclosure provide for estimating or predicting coating usage for different applications, such as repair mixes for automotive applications, aerospace applications, etc.; but they can readily be applied to other surface applications, such as structure coating application (e.g., houses, commercial, industrial structures), marine applications, outdoor structure treatment (e.g., staining, waterproofing), and many others.

In the illustrated example, the input data 204 includes coating variables, wherein the coating usage estimation processor 202 processes the input data 204 using one or more estimation algorithms 206 as described in more detail herein. In some examples, the coating usage estimation algorithms 206 can be any type of algorithm used to determine an output amount of material needed for mixed coating based on one or more coating inputs. That is, the input data 204 is used to determine coating properties for the surface coating application based on the received input data 204 and estimate an amount of coating for the surface coating application based on the determined coating properties as described in more detail herein. The amount of coating predicted can change based on the type of coverage or rate of coverage of a particular type of coating as it is applied to a target surface material, using a target method of application.

In the implementation illustrated in FIG. 2, the coating usage estimation processor 202 also can perform processing using one or more color match accuracy algorithms 208. For example, an estimated color match accuracy is determined by the one or more color match accuracy algorithms 208 and used to adjust the coating amount estimation or prediction. That is, based on a determined accuracy of the color match, a coating mix amount, namely the amounts of the component materials used for the coating, can be increased or decreased.

With the input data 204 processed as described above, the coating usage estimation processor 202 generates an output 210 corresponding to the estimated or predicted amount of coating. For example, in some painting applications, for the estimated or predicted amount of coating, the output 210 includes an estimated or predicted amount of primer, an estimated or predicted amount of basecoat, and/or an estimated or predicted amount of clearcoat for the application.

In addition, with respect to the coating usage estimation processor 202, various parameters, etc. can be specified by an operator. For example, an operator is able to specify values of different inputs, availability of products or materials, etc. using a control interface 212 (e.g., a graphical user interface). Once the operator has configured one or more parameters, the coating usage estimation processor 202 is configured to perform coating amount estimation or prediction as described herein. It should be noted that in some examples, the coating usage predictor 100 or components thereof are configured as a downloadable application that can be stored and loaded to one or more end user devices such as a smart phone 214, a laptop computer 216, or other end user computing device, or remote computing device (e.g., cloud or server based). The end user computing device is able to use the coating usage predictor 100 to carry out one or more tasks, such as estimating or predicting an amount of coating for the surface coating application.

In some implementations, the coating usage predictor 100 and/or the coating usage prediction system 200 is operable and configured to perform a method that determines the amount of coating in a painting application (e.g., paint primer, basecoat, and clearcoat) needed to complete a repair as follows:
1. The primer and clear coat amounts are based on an area to be sprayed. The basecoat amount is determined by an area of repair, the hiding ability of the color, and the predicted accuracy of the color (the greater the accuracy, the smaller the area of blending needed and the lesser the accuracy, the greater the area of blending needed).
2. Using the estimated color match accuracy based on spectral readings of the repair area and a search of available paint formulas, plus the accuracy of the coating measuring device (volumetric or gravimetric), the system calculates and applies a factor to increase or decrease the estimated coating mix amount. For colors with a very low predicted match accuracy, the system can automatically recommend a sample spray out for color verification.
3. The estimated mix amount is used to create more accurate cost estimates for the coating or surface coating application.

It should be noted that various examples use one or more of spectrophotometric data from repair and available color library, color match accuracy algorithm(s), minimum measurement accuracy for coating measuring device(s), and an estimate factor or suggested sample spray out based on estimate color match accuracy to perform the operations described herein. In some examples, mix amount recommendations are combined with the estimated color match accuracy to generate a final a mix amount for the surface coating application.

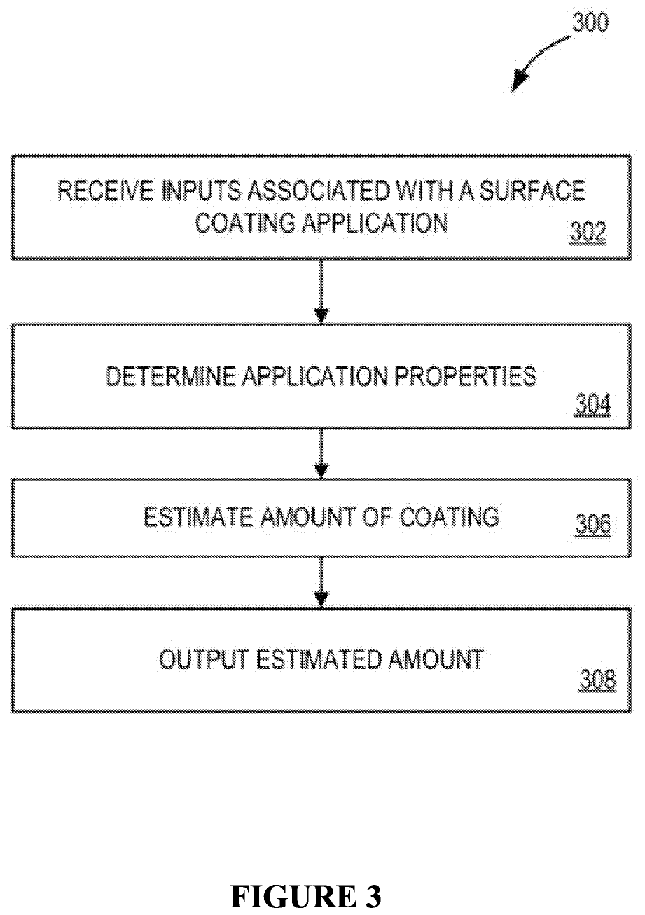

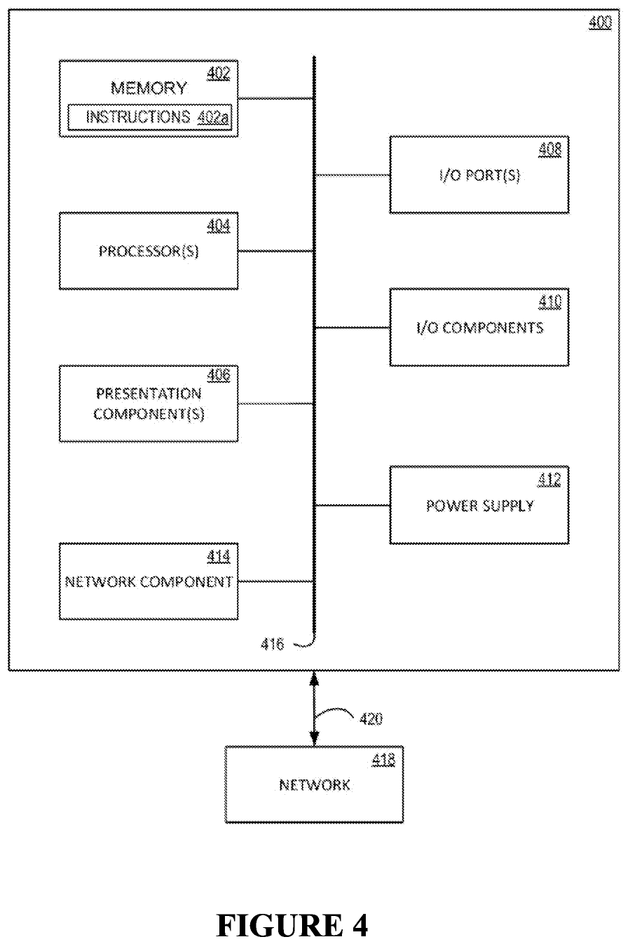

FIG. 3 is a flowchart 300 illustrating operations involved in coating usage estimation or prediction according to one implementation. In some examples, the operations of the flowchart 300 are performed by the coating usage predictor 100, the coating usage prediction system 200, and/or a computing device 400 illustrated in FIG. 4 (which may form part of or implement part of the coating usage predictor 100 and/or the coating usage prediction system 200). The flowchart 300 commences with operation 302 that includes receiving a plurality of inputs associated with a surface coating application, wherein the plurality of inputs include one or more of a target coating surface area, a method of application of the coating, a surface substrate type, and a coating type as described herein.

At operation 304, application properties for the surface coating application are determined based on the received plurality of inputs. The properties can include any type of property, for example, relating to the manner in which the surface coating is to be applied (e.g., application tool, application thickness, etc.).

At operation 306, an amount of coating sufficient to complete the surface coating application is estimated based on the determined application properties. For example, an amount of the different materials to produce a total amount of mixed coating for the application is estimated. In some examples, one or more of the following are estimated: an amount of primer for the surface coating application, an amount of basecoat for the surface coating application, and an amount of clearcoat for the surface coating application.

In one example, the target coating surface area includes an area to be coated and a repair area, and the estimated amount of primer and the estimated amount of clearcoat are based at least in part on the area to be coated. In another example, the target coating surface area includes an area to be coated and a repair area, and the application properties for the surface coating application are determined based at least in part on a hiding ability of a color for the surface coating application and a predicted color match accuracy, wherein the estimated amount of the basecoat is based at least in part on the repair area, the hiding ability of the color for the surface coating application and the predicted color match accuracy. A factor can then be applied to increase or decrease the estimated amount of coating based on the predicted color match accuracy. In some examples, the predicted color match accuracy is based at least in part on one or more spectral readings of the repair area, available coating formulas, and an accuracy of a coating measuring device.

At operation 308, the estimated amount of coating corresponding to the total amount of mixed coating to be prepared for the surface coating application is output. For example, the material types, material amounts (e.g., mix amounts corresponding to the amount of coating for the surface coating application based on the determined application properties and an estimated color match accuracy), and cost (e.g., cost estimate corresponding to the surface coating application based on the estimated amount of coating) for the mixed coating are displayed to a user. Other outputs may be provided, such as a recommendation for a color spray out in response to the predicted color match accuracy being below a defined threshold.

Thus, one or more implementations allow for more accurate prediction of an amount of coating for a surface coating application. For example, an amount of paint to be made is more accurately estimated, such as to paint a damaged recreation vehicle (RV), wherein the system predicts the coating amounting us one or more of: formula, color, application, overspray, amount of waste (e.g., in tube of sprayer). In some example, the prediction is an amount enough to cover the target coating surface area, such as with specialty paints.

With reference now to FIG. 4, a block diagram of the computing device 400 suitable for implementing various aspects of the disclosure is described (e.g., a monitoring system). FIG. 4 and the following discussion provide a brief, general description of a computing environment in/on which one or more or the implementations of one or more of the methods and/or system set forth herein may be implemented. The operating environment of FIG. 4 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

In some examples, the computing device 400 includes a memory 402, one or more processors 404, and one or more presentation components 406. The disclosed examples associated with the computing device 400 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 5 and the references herein to a “computing device.” The disclosed examples are also practiced in distributed computing environments, where tasks are performed by remote-processing devices that are linked through a communications network. Further, while the computing device 400 is depicted as a single device, in one example, multiple computing devices work together and share the depicted device resources. For instance, in one example, the memory 402 is distributed across multiple devices, the processor(s) 504 provided are housed on different devices, and so on.

In one example, the memory 402 includes any of the computer-readable media discussed herein. In one example, the memory 402 is used to store and access instructions 402a configured to carry out the various operations disclosed herein. In some examples, the memory 402 includes computer storage media in the form of volatile and/or nonvolatile memory, removable or non-removable memory, data disks in virtual environments, or a combination thereof. In one example, the processor(s) 404 includes any quantity of processing units that read data from various entities, such as the memory 402 or input/output (I/O) components 410. Specifically, the processor(s) 404 are programmed to execute computer-executable instructions for implementing aspects of the disclosure. In one example, the instructions 402a are performed by the processor 404, by multiple processors within the computing device 400, or by a processor external to the computing device 400. In some examples, the processor(s) 404 are programmed to execute instructions such as those illustrated in the flow charts discussed herein and depicted in the accompanying drawings.

In other implementations, the computing device 400 may include additional features and/or functionality. For example, the computing device 400 may also include additional storage (e.g., removable and/or non-removable) including, but not limited to, magnetic storage, optical storage, and the like. Such additional storage is illustrated in FIG. 4 by the memory 402. In one implementation, computer readable instructions to implement one or more implementations provided herein may be in the memory 402 as described herein. The memory 402 may also store other computer readable instructions to implement an operating system, an application program and the like. Computer readable instructions may be loaded in the memory 402 for execution by the processor(s) 404, for example.

The presentation component(s) 406 present data indications to an operator or to another device. In one example, the presentation components 406 include a display device, speaker, printing component, vibrating component, etc. One skilled in the art will understand and appreciate that computer data is presented in a number of ways, such as visually in a graphical user interface (GUI), audibly through speakers, wirelessly between the computing device 400, across a wired connection, or in other ways. In one example, the presentation component(s) 406 are not used when processes and operations are sufficiently automated that a need for human interaction is lessened or not needed. I/O ports 408 allow the computing device 400 to be logically coupled to other devices including the I/O components 410, some of which is built in. Implementations of the I/O components 410 include, for example but without limitation, a microphone, keyboard, mouse, joystick, pen, game pad, satellite dish, scanner, printer, wireless device, camera, etc.

The computing device 400 includes a bus 416 that directly or indirectly couples the following devices: the memory 402, the one or more processors 404, the one or more presentation components 406, the input/output (I/O) ports 408, the I/O components 410, a power supply 412, and a network component 514. The computing device 400 should not be interpreted as having any dependency or requirement related to any single component or combination of components illustrated therein. The bus 416 represents one or more busses (such as an address bus, data bus, or a combination thereof). Although the various blocks of FIG. 4 are shown with lines for the sake of clarity, some implementations blur functionality over various different components described herein.

The components of the computing device 400 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 400 may be interconnected by a network. For example, the memory 402 may be comprised of multiple physical memory units located in different physical locations interconnected by a network.

In some examples, the computing device 400 is communicatively coupled to a network 418 using the network component 414. In some examples, the network component 414 includes a network interface card and/or computer-executable instructions (e.g., a driver) for operating the network interface card. In one example, communication between the computing device 400 and other devices occurs using any protocol or mechanism over a wired or wireless connection 420. In some examples, the network component 414 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 420 may include, but is not limited to, a modem, a Network Interface Card (NIC), an integrated network interface, a radio frequency transmitter/receiver, an infrared port, a USB connection or other interfaces for connecting the computing device 400 to other computing devices. The connection 420 may transmit and/or receive communication media.

Although described in connection with the computing device 400, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

### EXAMPLE EMBODIMENTS

Embodiment 1—One embodiment for a system for surface coating application usage estimation can comprise a processor and a computer-readable medium storing non-transitory instructions that are operative upon execution by the processor to: receive a plurality of inputs (104, 204) associated with a surface coating application, the plurality of inputs comprising one or more of a target coating surface area, a method of application of the coating, a surface substrate type, and a coating type; determine application properties for the surface coating application based on the received plurality of inputs; estimate an amount of coating sufficient to complete the surface coating application based on the determined application properties; and output the estimated amount of coating corresponding to a total amount of coating to be prepared for the surface coating application.

Embodiment 2—the system of embodiment 1, wherein the computer-readable medium is further operative upon execution by the processor to estimate one or more of: an amount of primer for the surface coating application, an amount of basecoat for the surface coating application, and an amount of clearcoat for the surface coating application.

Embodiment 3—the system of embodiment 1 or 2, wherein the target coating surface area comprises an area to be coated and a repair area, and the estimated amount of primer and the estimated amount of clearcoat are based at least in part on the area to be coated.

Embodiment 4—the system of any of the preceding embodiments, wherein target coating surface area comprises an area to be coated and a repair area, and the computer-readable medium is further operative upon execution by the processor to determine the application properties for the surface coating application based at least in part on a hiding ability of a color for the surface coating application and a predicted color match accuracy, wherein the estimated amount of the basecoat is based at least in part on the repair area, the hiding ability of the color for the surface coating application and the predicted color match accuracy.

Embodiment 5—the system of any of the preceding embodiments, wherein the computer-readable medium is further operative upon execution by the processor to calculate and apply a factor to increase or decrease the estimated amount of coating based on the predicted color match accuracy.

Embodiment 6—the system of any of the embodiments 1-4, wherein the predicted color match accuracy is based at least in part on one or more spectral readings of the repair area, available coating formulas, and an accuracy of a coating measuring device.

Embodiment 7—the system of any of the embodiments 1-4, wherein the computer-readable medium is further operative upon execution by the processor to recommend a color spray out in response to the predicted color match accuracy being below a defined threshold.

Embodiment 8—the system of any of the embodiment 1-7, wherein the wherein the computer-readable medium is further operative upon execution by the processor to output a cost estimate corresponding to the surface coating application based on the estimated amount of coating.

Embodiment 9—the system of any of the embodiments 1-8, wherein the computer-readable medium is further operative upon execution by the processor to estimate a mix amount corresponding to the amount of coating for the surface coating application based on the determined application properties and an estimated color match accuracy.

Embodiment 10—One embodiment of a method for surface coating application usage estimation can comprises the steps of: receiving a plurality of inputs associated with a surface coating application, the plurality of inputs comprising one or more of a target coating surface area, a method of application of the coating, a surface substrate type, and a coating type; determining application properties for the surface coating application based on the received plurality of inputs: estimating an amount of coating sufficient to complete the surface coating application based on the determined application properties; and outputting the estimated amount of coating corresponding to a total amount of coating to be prepared for the surface coating application.

Embodiment 11—the method of embodiment 10, further comprising estimating one or more of: an amount of primer for the surface coating application, an amount of basecoat for the surface coating application, and an amount of clearcoat for the surface coating application.

Embodiment 12—the method of the embodiments 10 or 11, wherein the target coating surface area comprises an area to be coated and a repair area, and the estimated amount of primer and the estimated amount of clearcoat are based at least in part on the area to be coated.

Embodiment 13—the method of any of the embodiments 10-12, wherein target coating surface area comprises an area to be coated and a repair area, and further comprising determining the application properties for the surface coating application based at least in part on a hiding ability of a color for the surface coating application and a predicted color match accuracy, wherein the estimated amount of the basecoat is based at least in part on the repair area, the hiding ability of the color for the surface coating application and the predicted color match accuracy.

Embodiment 14—the method of any of the embodiments 10-13, further comprising calculating and applying a factor to increase or decrease the estimated amount of coating based on the predicted color match accuracy.

Embodiment 15—the method of any of the embodiments 10-13, wherein the predicted color match accuracy is based at least in part on one or more spectral readings of the repair area, available coating formulas, and an accuracy of a coating measuring device.

Embodiment 16—the method of any of the embodiments 10-13, further comprising recommending a color spray out in response to the predicted color match accuracy being below a defined threshold.

Embodiment 17—the method of any of the embodiments 10-16, further comprising outputting (308) a cost estimate corresponding to the surface coating application based on the estimated amount of coating.

Embodiment 18—the method of any of the embodiments 10-17, further comprising estimating (306) a mix amount corresponding to the amount of coating for the surface coating application based on the determined application properties and an estimated color match accuracy.

Embodiment 19—One embodiment for a system for surface coating application usage estimation can comprise: a user interface comprising an input/output device to input data indicative of characteristics of a surface coating application and to output information indicative of an estimated amount of coating for the surface coating application; and a control unit operably coupled with the user interface that comprises: a processor for processing data and instructions; and memory storing programming that is operative upon execution by the processor, where the programming comprises instructions indicative of the steps of: receiving a plurality of inputs associated with a surface coating application, the plurality of inputs comprising one or more of a target coating surface area, a method of application of the coating, a surface substrate type, and a coating type; determining application properties for the surface coating application based on the received plurality of inputs; estimating an amount of coating sufficient to complete the surface coating application based on the determined application properties; and outputting the estimated amount of coating corresponding to a total amount of coating to be prepared for the surface coating application to the user interface.

Embodiment 20—the system of embodiments 19, wherein the programming further comprising instructions indicative of estimating an amount of waste coating for the surface coating application in addition to the total amount of coating to be prepared for the surface coating application, the amount of waste coating indicative of an amount expected to be wasted during the surface coating application.

Implementations of the disclosure are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid- state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

1. A system for a surface coating application usage estimation, the system comprising:
a processor; and
a computer-readable medium storing non-transitory instructions that are operative upon execution by the processor to:
receive a plurality of inputs associated with a surface coating application, the plurality of inputs comprising one or more of a target coating surface area, a method of application of the coating, a surface substrate type, and a coating type;
determine application properties for the surface coating application based on the received plurality of inputs;
estimate an amount of coating sufficient to complete the surface coating application based on the determined application properties; and
output the estimated amount of coating corresponding to a total amount of coating to be prepared for the surface coating application.

2. The system of claim 1, wherein the computer-readable medium is further operative upon execution by the processor to estimate one or more of: an amount of primer for the surface coating application, an amount of basecoat for the surface coating application, and an amount of clearcoat for the surface coating application.

3. The system of claim 1, wherein the target coating surface area comprises an area to be coated and a repair area, and the estimated amount of primer and the estimated amount of clearcoat are based at least in part on the area to be coated.

4. The system of any claim 1, wherein target coating surface area comprises an area to be coated and a repair area, and the computer-readable medium is further operative upon execution by the processor to determine the application properties for the surface coating application based at least in part on a hiding ability of a color for the surface coating application and a predicted color match accuracy, wherein the estimated amount of the basecoat is based at least in part on the repair area, the hiding ability of the color for the surface coating application and the predicted color match accuracy.

5. The system of claim 1, wherein the computer-readable medium is further operative upon execution by the processor to calculate and apply a factor to increase or decrease the estimated amount of coating based on the predicted color match accuracy.

6. The system of claim 1, wherein the predicted color match accuracy is based at least in part on one or more spectral readings of the repair area, available coating formulas, and an accuracy of a coating measuring device.

7. The system of claim 1, wherein the computer-readable medium is further operative upon execution by the processor to recommend a color spray out in response to the predicted color match accuracy being below a defined threshold.

8. The system of claim 1, wherein the wherein the computer-readable medium is further operative upon execution by the processor to output a cost estimate corresponding to the surface coating application based on the estimated amount of coating.

9. The system of claim 1, wherein the computer-readable medium is further operative upon execution by the processor to estimate a mix amount corresponding to the amount of coating for the surface coating application based on the determined application properties and an estimated color match accuracy.

10. A method for surface coating application usage estimation, the method comprising:
receiving a plurality of inputs associated with a surface coating application, the plurality of inputs comprising one or more of a target coating surface area, a method of application of the coating, a surface substrate type, and a coating type;
determining application properties for the surface coating application based on the received plurality of inputs;
estimating an amount of coating sufficient to complete the surface coating application based on the determined application properties; and
outputting the estimated amount of coating corresponding to a total amount of coating to be prepared for the surface coating application.

11. The method of claim 10, further comprising estimating one or more of: an amount of primer for the surface coating application, an amount of basecoat for the surface coating application, and an amount of clearcoat for the surface coating application.

12. The method of claim 10, wherein the target coating surface area comprises an area to be coated and a repair area, and the estimated amount of primer and the estimated amount of clearcoat are based at least in part on the area to be coated.

13. The method of claim 10, wherein target coating surface area comprises an area to be coated and a repair area, and further comprising determining the application properties for the surface coating application based at least in part on a hiding ability of a color for the surface coating application and a predicted color match accuracy, wherein the estimated amount of the basecoat is based at least in part on the repair area, the hiding ability of the color for the surface coating application and the predicted color match accuracy.

14. The method of claim 10, further comprising calculating and applying a factor to increase or decrease the estimated amount of coating based on the predicted color match accuracy.

15. The method of claim 10, wherein the predicted color match accuracy is based at least in part on one or more spectral readings of the repair area, available coating formulas, and an accuracy of a coating measuring device.

16. The method of claim 10, further comprising recommending a color spray out in response to the predicted color match accuracy being below a defined threshold.

17. The method of claim 10, further comprising outputting a cost estimate corresponding to the surface coating application based on the estimated amount of coating.

18. The method of claim 10, further comprising estimating a mix amount corresponding to the amount of coating for the surface coating application based on the determined application properties and an estimated color match accuracy.

19. A system for estimating an amount of coating for a surface coating application, comprising:
a user interface comprising an input/output device to input data indicative of characteristics of a surface coating application and to output information indicative of an estimated amount of coating for the surface coating application;
a control unit operably coupled with the user interface, and comprising:
a processor for processing data and instructions; and
memory storing programming that is operative upon execution by the processor, the programming comprising instructions indicative of the steps of:
receiving a plurality of inputs associated with a surface coating application, the plurality of inputs comprising one or more of a target coating surface area, a method of application of the coating, a surface substrate type, and a coating type;
determining application properties for the surface coating application based on the received plurality of inputs;
estimating an amount of coating sufficient to complete the surface coating application based on the determined application properties; and
outputting the estimated amount of coating corresponding to a total amount of coating to be prepared for the surface coating application to the user interface.

20. The system of claim 19, the programming further comprising instructions indicative of estimating an amount of waste coating for the surface coating application in addition to the total amount of coating to be prepared for the surface coating application, the amount of waste coating indicative of an amount expected to be wasted during the surface coating application.
